(19) United States
(12) Patent Application Publication
(10) Pub. No.: US 2012/0077352 A1
(43) Pub. Date: Mar. 29, 2012

(54) CONNECTION DEVICE FOR DATA COLLECTION DEVICE

(75) Inventors: Elianna Rose Weyer, Greenville, SC (US); Corey Malone McBain, Bremerton, WA (US)

(73) Assignee: GENERAL ELECTRIC COMPANY, Schenectady, NY (US)

(21) Appl. No.: 12/891,187

(22) Filed: Sep. 27, 2010

(51) Int. Cl. H01R 11/30; H01R 24/00

(52) U.S. Cl. 439/39; 439/660

(57) ABSTRACT

A connection device for releasably connecting a sensor and a data collector is disclosed. The connection device includes a male component connected to one of the sensor or the data collector and a female component connected to the other of the sensor or the data collector. The connection device further includes a coupler associated with one of the male component or the female component and a mating coupler associated with the other of the male component or the female component for releasably connected the male component and the female component together. Further, the connection device includes a plurality of pins associated with the male component and a plurality of pads associated with the female component. At least a portion of the plurality of pins and a portion of the plurality of pads are configured to flow data therethrough such that the sensor and the data collector are in communication.

### FIELD OF THE INVENTION

The present disclosure relates generally to data collection devices, and more particularly to connection devices for releasably connecting sensors to data collectors such that the sensors and data collectors may flow data therebetween.

### BACKGROUND OF THE INVENTION

Data collection devices are frequently utilized to collect data from various sources. The data may, for example, be transmitted through the data collection device to another device for analysis, or may be analyzed within the data collection device. A typical data collection device may include a sensor for initially obtaining the data and a data collector for collecting the data from the sensor and storing the data. The data collector may further analyze, organize, and/or manage the collected data.

In many cases, it may be advantageous for the sensor to be a separate component from the data collector. For example, various sensors may be produced for obtaining various different types of data, and these sensors may all be utilized with one data collector. These sensors must be quickly and easily interchanged in order to ensure proper data collection.

Further, data collection devices are frequently utilized in industrial applications, such as, for example, to monitor the performance of gas turbine systems. Various sensors are configured to monitor various aspects of the performance of the system, such as distances, temperatures, pressures, displacements, velocities, accelerations, and efficiencies. These sensors must be easily and quickly accessible and transportable as required per application, and must further be quickly and easily connectable and disconnectable from associated data collectors.

However, typical data collection devices do not allow for quick, easy access to and interchange of sensors, or quick, easy connection and disconnection of sensors from associated data collectors. For example, data collection devices typically include a variety of wires connecting a sensor and a data collector together for transporting data therebetween, and may further include various fastening devices designed to hold the sensor and data collector together. These wires and fastening devices may make the separation of a sensor from a data collector complicated and time consuming. Further, if the data collection device were to be involved in an accident such as, for example, if the data collection device were dropped during use, the wires and fastening devices connecting the sensor and data collector may increase the likelihood that both the sensor and the data collector would be involved in the accident and possibly damaged.

Thus, an improved connection device for a data collection device would be desired in the art. For example, a connection device that allows a sensor to be quickly and easily connected and disconnected from a data collector would be advantageous. Further, a connection device that would reduce the likelihood that both the sensor and the data collector were damaged as the result of an accident would be desired.

### BRIEF DESCRIPTION OF THE INVENTION

Aspects and advantages of the invention will be set forth in part in the following description, or may be obvious from the description, or may be learned through practice of the invention.

In one embodiment, a connection device for releasably connecting a sensor and a data collector is disclosed. The connection device includes a male component connected to one of the sensor or the data collector and a female component connected to the other of the sensor or the data collector. The connection device further includes a coupler associated with one of the male component or the female component and a mating coupler associated with the other of the male component or the female component for releasably connecting the male component and the female component together. Further, the connection device includes a plurality of pins associated with the male component and a plurality of pads associated with the female component. At least a portion of the plurality of pins and a portion of the plurality of pads are configured to flow data therethrough such that the sensor and the data collector are in communication.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a connection device for a data collection device according to one embodiment of the present disclosure;

FIG. 2 is a perspective view of a connection device for a data collection device according to another embodiment of the present disclosure; and

FIG. 3 is a perspective view of a connection device for a data collection device according to yet another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

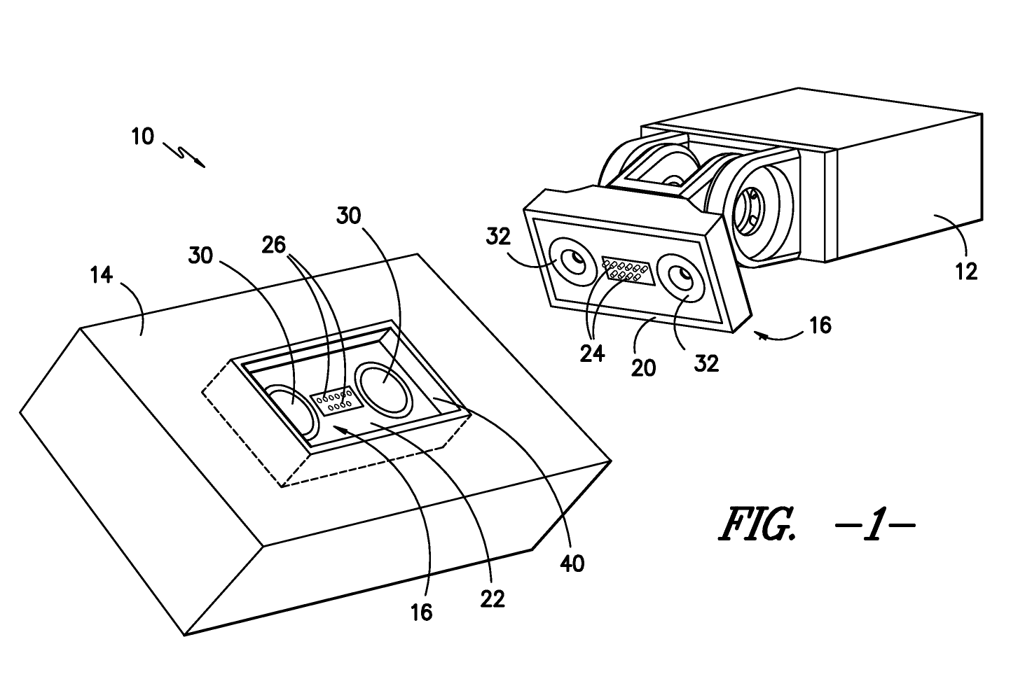

Referring to FIGS. 1 through 3, various embodiments of a data collection device 10 according to the present disclosure are illustrated. In general, the data collection device 10 includes a sensor 12 and a data collector 14. The sensor 12 is generally configured to obtain data. The data collector 14 is generally configured to collect the data from the sensor 12, and may further be configured to analyze, organize, and/or manage the collected data.

For example, in exemplary embodiments, the data collection device 10 may be utilized in a power plant or other industrial application, and may be operated to collect data with regard to, for example, gas turbine systems or other machinery or auxiliary equipment. In some embodiments, the sensor 12 may be any suitable sensor configured to, for example, directly measure various types of data. In alternative embodiments, the sensor 12 may be any suitable sensor configured to, for example, receive transmissions of data measurements from other devices, such as transmitting sensors mounted inside various components of the gas turbine systems or other machinery or auxiliary equipment. The various types of data obtained by the sensor 12 may include, for example, distances, temperatures, pressures, displacements, velocities, accelerations, efficiencies, or any other suitable types of data. It should be understood that the above examples are non-limiting, and that any suitable sensor for obtaining any data in a power plant or other industrial application is within the scope and spirit of the present disclosure.

The data collector 14 may be any suitable device configured to collect the data from the sensor 12. Further, the data collector 14 may be configured to analyze, organize, and manage the collected data. For example, in some embodiments, the data collector 14 may be any suitable computer or processor. In exemplary embodiments, the data collector 14 may be a generally portable device. For example, the data collector 14 may be a laptop, tablet, or handheld computer, or any other suitable portable processing device.

In general, the sensor 12 and data collector 14 according to the present disclosure must be connected together such that they are in communication, such that the data obtained by the sensor 12 may be communicated to the data collector 14. Many various sensors 12 may be utilized to obtain various types of data, and these sensors 12 may need to be connected to a singular data collector 14 or a group of data collectors 14. Thus, the sensors 12 and data collectors 14 may need to be quickly and easily connected to and disconnected from each other. Further, because the data collector 14 may be portable, the connection between the sensors 12 and the data collectors 14 may need to be configured such that, if the data collection device 10 is involved in an accident, the likelihood that both the sensor 12 and the data collector 14 are damaged as a result of the accident is reduced.

Thus, the data collection device 10 of the present disclosure further includes a connection device 16 for releasably connecting the sensor 12 and the data collector 14. The connection device 16 includes a male component 20 and a female component 22. The male component 20 may be connected to one of the sensor 12 or the data collector 14. The female component 22 may be connected to the other of the sensor 12 or the data collector 14. As discussed below, the male and female components 20, 22 of the connection device 16 include various apparatus for releasably connecting the sensor 12 and the data collector 14 together, and for flowing data therebetween.

For example, the connection device 16 may include a plurality of pins 24 and a plurality of pads 26. The pins 24 may be generally associated with the male component 20, thus defining that component as a male component 20, while the pads 26 may be generally associated with the female component 22, thus defining that component as a female component 22. In exemplary embodiments, an equal number of pins 24 and pads 26 may be provided in the connection device. Further, the pins 24 and pads 26 may be similarly positioned on the respective male and female components 20, 22. Thus, each of the pins 24 may have a mating pad 26, and vice versa. For example, FIGS. 1 through 3 each illustrate ten pins 24 and ten mating pads 26. It should be understood, however, that the present disclosure is not limited to ten pins 24 and pads 26, and that any suitable equal or non-equal number of pins 24 and pads 26 is within the scope and spirit of the present disclosure.

In general, at least a portion of the plurality of pins 24 and pads 26 may be configured to flow data therethrough, such that the sensor 12 and the data collector 14 are in communication. Thus, data obtained by the sensor 12 may be communicated to and collected by the data collector 14 through the connection device 16. For example, the pins 24 and pads 26 may each be connected through the male and female components 20, 22 to the sensor 12 and data collector 14. In other words, the pins 24 may be connected through the male component 20 to one of the sensor 12 or the data collector 14, while the pads 26 may be connected through the female component 22 to the other of the sensor 12 or the data collector 14. The pins 24 and pads 26 may be connected to the sensor 12 and data collector 14 through, for example, other pins, wires or another suitable communicative connection. For example, in an exemplary embodiment, the pads 26 may be the female ends of a plurality of pins (not shown), and these pins may be connected to the sensor 12 or data collector 14 through other pins internal to the female component 22, other pins associated with the sensor 12 or data collector 14, or wires or another suitable communicative connection. In further exemplary embodiments, the pins 24 may be connected to the other of the sensor 12 or data collector 14 through other pins internal to the male component 20, other pins associated with the sensor 12 or data collector 14, or wires or another suitable communicative connection.

In one particular exemplary embodiment, at least one of the pins 24, or a plurality of the pins 24, may be spring-pins. Thus, when the pins 24 mate with the pads 26, the pins 24 may retract into the male component 20. Upon retraction, the pins 24 may contact other pins internal to the male component 20, other pins associated with the sensor 12 or data collector 14, or wires or another suitable communicative connection.

Thus, the pins 24 and pads 26 may each be connected through the male and female components 20, 22 to the sensor 12 and data collector 14. When the male and female components 20, 22 of the connection device 16 are connected together, such that the pins 24 and pads 26 mate, the sensor 12 and data collector 14 may therefore be in communication such that data may be flowed therebetween.

In some exemplary embodiments, all of the pins 24 and pads 26 are configured to flow data therethrough. In these embodiments, the sensor 12 may, for example, be powered through batteries or a suitable external power source. In other exemplary embodiments, a portion of the plurality of pins 24 and pads 26 are configured to flow electricity therethrough. In these embodiments, the sensor 12 may thus be powered through the connection device 16 by the data collector 14. The data collector 14 may generally be powered by, for example, batteries or a suitable external power source.

The connection device 16 may further include at least one coupler 30 and at least one mating coupler 32, or a plurality of couplers 30 and a plurality of mating couplers 32. The coupler 30, or each of the couplers 30, may be associated with one of the male component 20 or the female component 22, and the mating coupler 32, or each of the mating couplers 32, may be associated with the other of the male component 20 or the female component 22. The couplers 30 and mating couplers 32 may be provided in the connection device 16 for releasably connecting the male component 20 and the female component 22 together. For example, the couplers 30 and mating couplers 32 may allow the sensors 12 and data collectors 14 to be quickly and easily connected to and disconnected from each other. Further, the couplers 30 and mating couplers 32 may, upon an unexpected movement of the sensor 12 or the data collector 14, allow the sensor 12 and the data collector 14 to disconnect. Thus, if the data collection device 10 is, for example, dropped or otherwise involved in an accident, the sensor 12 and data collector 14 may, as a result of the releasable connecting of the couplers 30 and mating couplers 32, separate from each other. This releasable connecting may decrease the likelihood that both the sensor 12 and the data collector 14 are damaged as a result of an accident or otherwise unexpected movement.

For example, in one exemplary embodiment, the coupler 30 may be a magnet, and the mating coupler 32 may be a magnetic plate. The magnetic plate may be, for example, a steel plate or a plate formed from any suitable metal, metal alloy, or other magnetic substance. The magnet and/or magnetic plate may be, for example, press-fit into the male component 20 and/or female component 22, bolted into the male component 20 and/or female component 22, or otherwise secured to the male component 20 and/or female component 22.

In one exemplary embodiment wherein the mating coupler 32 is a magnetic plate, the magnetic plate may be associated with the one of the male component 20 or female component 22 that is connected to the sensor 12. In this embodiment, the mating coupler 32 may be advantageously utilized for storage of the sensor 12. For example, the sensor 12 according to this embodiment, when separated from the data collector 14, could be stored on a magnet rail or surface in, for example, a tool room or laboratory, or on, for example, a tool belt. In an alternative embodiment wherein the coupler 30 is a magnet, the magnet may be associated with the one of the male component 20 or female component 22 that is connected to the sensor 12. In this embodiment, the coupler 30 may be advantageously utilized for storage of the sensor 12. For example, the sensor 12 according to this embodiment, when separated from the data collector 14, could be stored on any suitable metal, metal alloy, or otherwise magnetic rail or surface in, for example, a tool room or laboratory, or on, for example, a tool belt.

It should be understood that the coupler 30 and mating coupler 32 of the present disclosure are not limited to magnets and magnetic plates, but rather may be any suitable devices for releasably connecting the male component 20 and female component 22 together. For example, the coupler 30 and mating coupler 32 may be mating hook and loop fasteners, mating pins and bore holes or any other suitable device that provide for releasable connecting as described above.

In some embodiments, one of the male component 20 or the female component 22 may include a lip 40 configured to accept the other of the male component 20 or the female component 22. The lip 40 may generally surround the outer periphery of the male or female component 20, 22. Thus, the lip 40 may assist in locating the male component 20 and female component 22 with respect to each other and thus connecting the male component 20 and female component 22 together.

The connection device 16 may further include various features for aligning the male component 20 and female component 22 with respect to each other. In general, these alignment features may allow the male component 20 and female component 22 to be connected in only one orientation. In other words, the connection device 16 may include various “poka-yoke”, or fail-safing or mistake-proofing, features.

For example, in one embodiment as shown in FIG. 1, the pins 24 and pads 26 may be positioned such that the male component 20 and female component 22 may be connected in only one orientation. FIG. 1 illustrates two rows of pins 24 and two rows of pads 26, with one row having six pins 24 or pads 26 and the other row having four pins 24 or pads 26. This arrangement of pins 24 and pads 26 ensures that the male component 20 and female component 22 may be connected in only one orientation, and that, for example, the male component 20 cannot be rotated 180 degrees and connected to the female component 22. It should be understood, however, that the present disclosure is not limited to two rows of pins 24 and pads 26 as discussed above. Rather, any suitable number of rows of pins 24 and pads 26 is within the scope and spirit of the present disclosure.

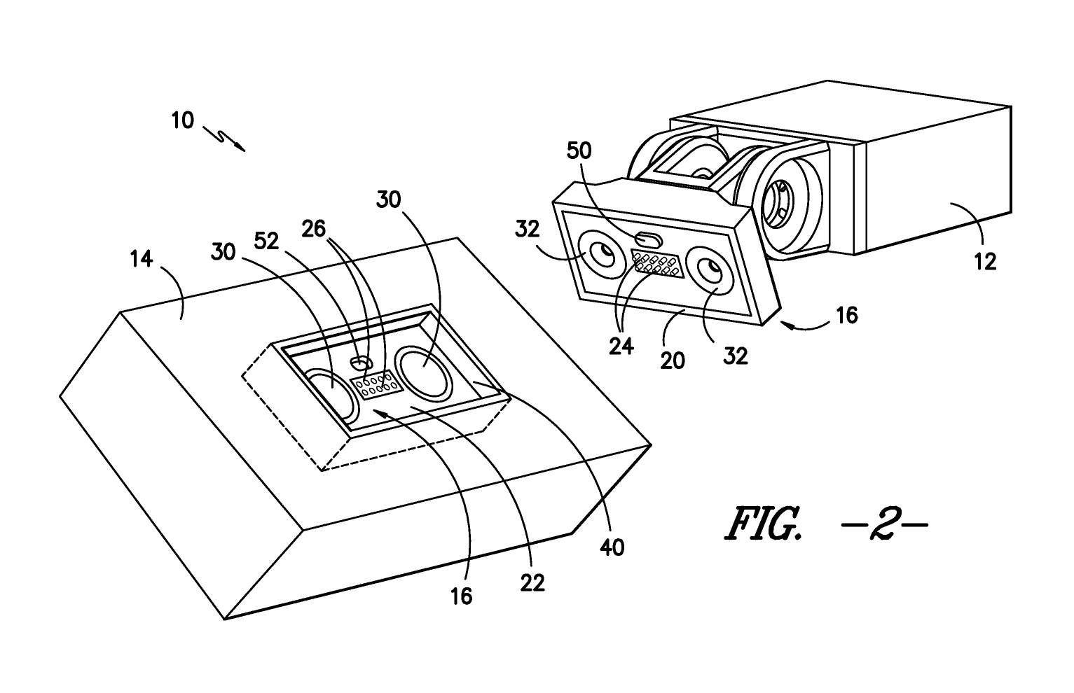

In another exemplary embodiment, as shown in FIG. 2, the connection device 16 may include an alignment feature 50 and an alignment groove 52, or a plurality of alignment features 50 and alignment grooves 52. Each alignment feature 50 may in general be a protrusion that is sized and shaped to mate with an alignment groove 52. Each alignment groove 52 may generally be a depression that is sized and shaped to mate with an alignment feature 50. The alignment feature 50, or each of the alignment features 50, may be associated with and protrude from one of the male component 20 or the female component 22, and the alignment groove 52, or each of the alignment grooves 52, may be associated with and defined in the other of the male component 20 or the female component 22. The alignment feature 50 and alignment groove 52 may be positioned such that the male component 20 and the female component 22 may be connected in only one orientation. For example, the alignment feature 50 and alignment groove 52 may be positioned in locations about the peripheries of the male component 20 and female component 22, or in other suitable locations on the faces of the male component 20 and female component 22 other than in the centers of the respective components 20, 22. Thus, in order for the alignment feature 50 and alignment groove 52 to properly mate such that the male component 20 and female component 22 may be connected, the male component 20 and female component 22 must be oriented correctly.

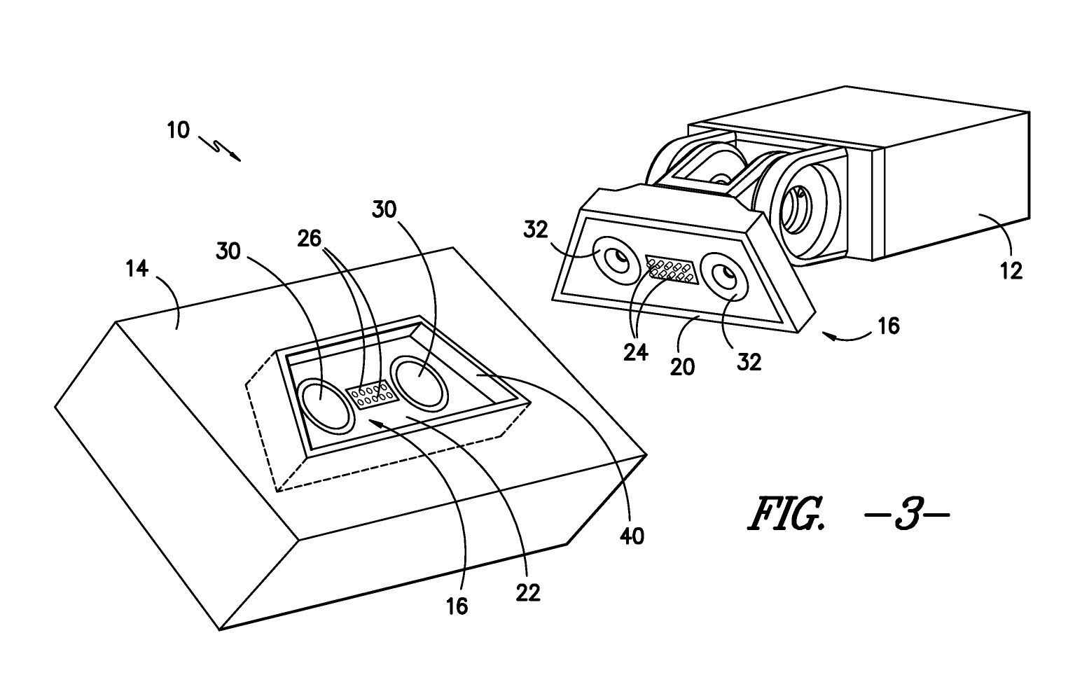

In another exemplary embodiment, as shown in FIG. 3, the male component 20 and female component 22 may be shaped such that the male component 20 and female component 22 may be connected in only one orientation. For example, as shown in FIG. 3, the components 20, 22 may be generally trapezoidally-shaped, such that the faces of the components 20, 22 are trapezoids. Thus, the components 20, 22 must be properly oriented in order for the trapezoidally-shaped faces to be properly connected. It should be understood, however, that the present disclosure is not limited to trapezoidially shaped components 20, 22. Rather, the components may be generally oval-shaped, rectangular-shaped, triangular-shaped, or may have any suitable polygonal shape.

Thus, the present data collection device 10 provides for an improved connection device 16 for releasably connecting a sensor 12 and data collector 14. The connection device 16 beneficially allows for the sensor 12 and data collector 14 to be quickly and easily connected to and disconnected from each other. Further, the connection device 16 of the present disclosure reduces the likelihood that both the sensor 12 and the data collector 14 will be damaged if the data collection device 10 is involved in an accident. In addition, in exemplary embodiments, the connection device 16 of the present disclosure may include various “poka-yoke”, or fail-safing or mistake-proofing, features, for ensuring proper connecting of the sensor 12 and data collector 14.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A connection device for releasably connecting a sensor and a data collector, the connection device comprising:
a male component connected to one of the sensor or the data collector;
a female component connected to the other of the sensor or the data collector;
a coupler associated with one of the male component or the female component and a mating coupler associated with the other of the male component or the female component for releasably connecting the male component and the female component together;
a plurality of pins and a plurality of pads, the plurality of pins associated with the male component, the plurality of pads associated with the female component, at least a portion of the plurality of pins and a portion of the plurality of pads configured to flow data therethrough such that the sensor and the data collector are in communication.

2. The connection device of claim 1, wherein a portion of the plurality of pins and a portion of the plurality of pads are configured to flow electricity therethrough.

3. The connection device of claim 1, further comprising a plurality of couplers, each of the plurality of couplers associated with one of the male component or the female component, and a plurality of mating couplers, each of the plurality of mating couplers associated with the other of the male component or the female component.

4. The connection device of claim 1, wherein the coupler is a magnet and the mating coupler is a magnetic plate.

5. The connection device of claim 4, wherein the magnetic plate is associated with the one of the male component or the female component that is connected to the sensor.

6. The connection device of claim 1, wherein the plurality of pins and the plurality of pads are positioned such that the male component and the female component may be connected in only one orientation.

7. The connection device of claim 1, further comprising an alignment feature associated with one of the male component or the female component and an alignment groove associated with the other of the male component or the female component, the alignment feature and the alignment groove positioned such that the male component and the female component may be connected in only one orientation.

8. The connection device of claim 1, wherein the male component and the female component are each shaped such that the male component and the female component may be connected in only one orientation.

9. The connection device of claim 1, wherein at least one of the plurality of pins is a spring-pin.

10. The connection device of claim 1, wherein one of the male component or the female component includes a lip configured to accept the other of the male component or the female component.

11. The connection device of claim 1, wherein the male component is connected to the sensor and the female component is connected to the data collector.

12. A data collection device, comprising:
a sensor;
a data collector;
a male component connected to one of the sensor or the data collector;
a female component connected to the other of the sensor or the data collector;
a coupler associated with one of the male component or the female component and a mating coupler associated with the other of the male component or the female component for releasably connecting the male component and the female component together;
a plurality of pins and a plurality of pads, the plurality of pins associated with the male component, the plurality of pads associated with the female component, at least a portion of the plurality of pins and a portion of the plurality of pads configured to flow data therethrough such that the sensor and the data collector are in communication.

13. The data collection device of claim 12, wherein a portion of the plurality of pins and a portion of the plurality of pads are configured to flow electricity therethrough.

14. The data collection device of claim 12, further comprising a plurality of couplers, each of the plurality of couplers associated with one of the male component or the female component, and a plurality of mating couplers, each of the plurality of mating couplers associated with the other of the male component or the female component.

15. The data collection device of claim 12, wherein the coupler is a magnet and the mating coupler is a magnetic plate.

16. The data collection device of claim 15, wherein the magnetic plate is associated with the one of the male component or the female component that is connected to the sensor.

17. The data collection device of claim 12, wherein the plurality of pins and the plurality of pads are positioned such that the male component and the female component may be connected in only one orientation.

18. The data collection device of claim 12, further comprising an alignment feature associated with one of the male component or the female component and an alignment groove associated with the other of the male component or the female component, the alignment feature and the alignment groove positioned such that the male component and the female component may be connected in only one orientation.

19. The data collection device of claim 12, wherein the male component and the female component are each shaped such that the male component and the female component may be connected in only one orientation.

20. The data collection device of claim 12, wherein at least one of the plurality of pins is a spring-pin.
